(19) United States
(12) Patent Application Publication
(10) Pub. No.: US 2003/0140157 A1
(43) Pub. Date: Jul. 24, 2003

(54) Removing data from contiguous data flows

(76) Inventor: Harlan T. Beverly, McDade, TX (US)

Correspondence Address: Timothy N. Trop, TROP, PRUNER & HU, P.C., STE 100, 8554 KATY FWY, HOUSTON, TX, 77024-1841, US

(21) Appl. No.: 10/054,406

(22) Filed: Jan. 22, 2002

(51) Int. Cl. G06F 15/16

(52) U.S. Cl. 709/231

(57) ABSTRACT

A contiguous data stream may have a data element removed to produce a contiguous, uninterrupted output data stream. This may be done by controlling a series of buffers, each of whose size corresponds to the element to be removed. For example, the element to be removed may not be written into a buffer and therefore is effectively lost. Alternatively, the element to be removed may be written into a buffer and thereafter overwritten with data that is not to be removed.

### BACKGROUND

This invention relates generally to removing data from contiguous data flows.

In a variety of circumstances, it may be desirable to remove data from a data flow. For example, in connection with virtual local area networks (VLANs) it is desirable, when receiving data, to strip VLAN tags. Since the data flow is at an extremely high rate, it would be desirable to remove the tags without unduly delaying the flow of data through the receiver.

It may be relatively easy to remove data from a contiguous data stream while leaving the data stream discontiguous or interrupted. However, if the data flow is interrupted, it would be very difficult to act on the data in a synchronous fashion.

Thus, there is a need for ways to remove data from contiguous data streams so as to an output a data stream that remains contiguous and uninterrupted.

### BRIEF DESCRIPTION OF THE DRAWINGS

FIG. 1 is a block depiction of one embodiment of the present invention;

FIG. 2 is a flow chart for software in accordance with one embodiment of the present invention;

FIG. 3 is a block depiction of another embodiment of the present invention; and

FIG. 4 is a flow chart for software in accordance with another embodiment of the present invention.

### DETAILED DESCRIPTION

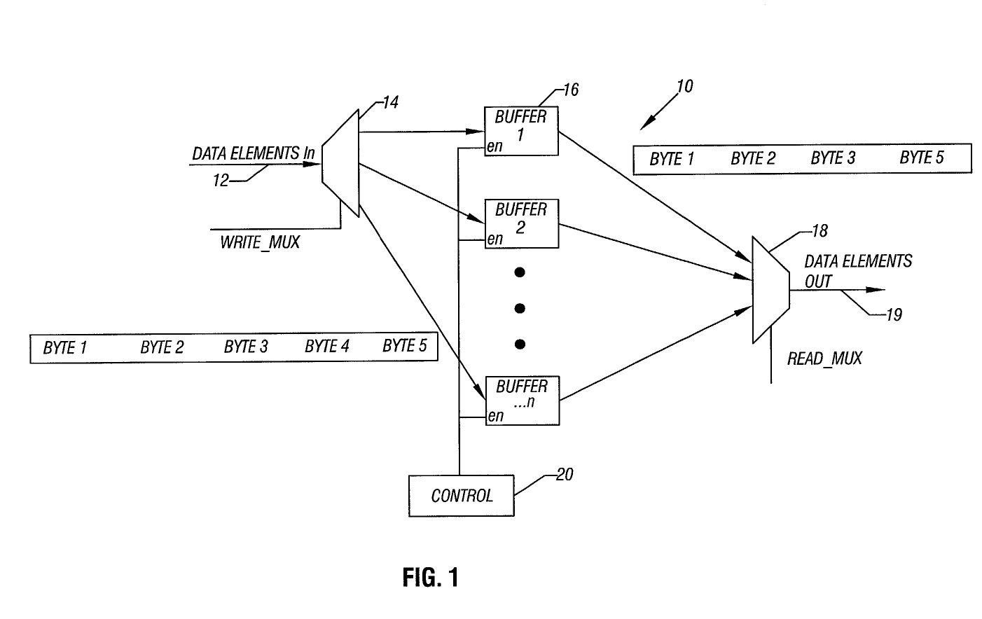

Referring to FIG. 1, an apparatus 10 may receive a contiguous stream of data 12 represented by the bytes 1-5 on the left side of FIG. 1 in one embodiment of the present invention. In that embodiment, the apparatus 10 may output a contiguous stream of data 19 with the byte 4 having been removed as indicated on the right side of FIG. 1.

The data elements may arrive as indicated at 12 to a write multiplexer 14. The write multiplexer 14 may receive a control signal from a control 20. The control 20 may be a processor, a state machine or any type of hardwired or processor-based controller. Each data element that is received in a packet or data stream may correspond in size to the size of the buffers 16. In other words, each of the buffers 16 may have a size equal to the size of a data element to be stripped, in one embodiment of the present invention.

In the example where it is desired to strip byte 4, the data elements may be defined to be of a size equal to the size of byte 4 and the buffers 16 are of a size equal to the size of byte 4. Thus, the successive bytes (e.g., 1-5) may be stored in the successive buffers 16 under the control of the multiplexer 14 in turn under control of the control 20. Once the buffers 16 have been loaded, they may be read out to the multiplexer 18 to produce a contiguous, uninterrupted output data stream, indicated at 19.

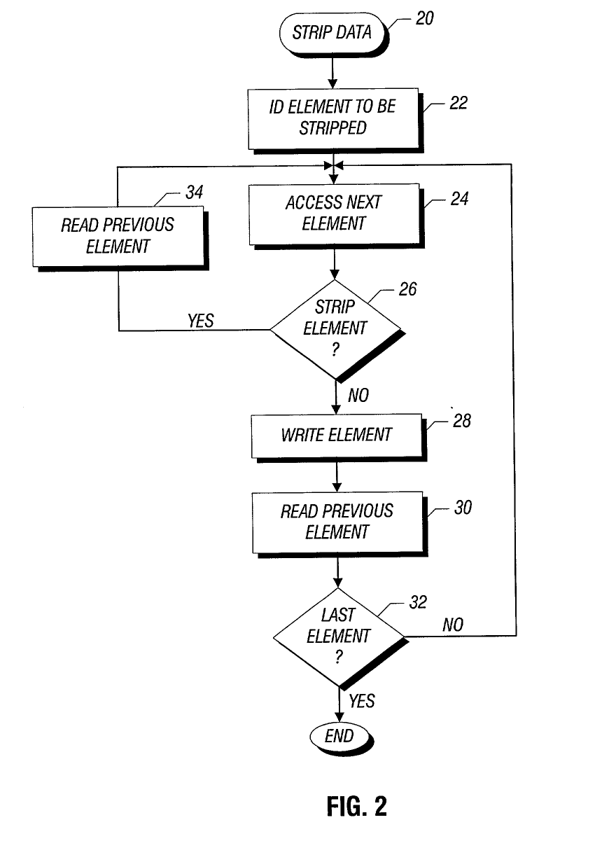

Referring to FIG. 2, the strip data software 20, that may reside within the control 20, controls the signals to the buffer 16 and the multiplexers 14 and 18 to strip the desired element from the data stream (for example the byte 4), in one embodiment of the present invention. If it is known that byte 4 is to be stripped, the control 20 can appropriately operate components to achieve this result. Thus, after the element to be stripped is identified (block 22), the first element in the data stream is accessed as indicated in block 24. The first element, such as the byte 5 in one example, may be provided to the buffer 16 labeled “buffer 1” in FIG. 1.

A check at diamond 26 determines whether the data element which has just been accessed is the element that is to be stripped. If not, the element is written into the appropriate buffer 16 as indicated in block 28. Next, the previously written element may be read out as indicated in block 30, in one embodiment.

Generally, it may be desirable to write an element into a buffer 16 in one clock or cycle and to read each element out in a subsequent clock or cycle. This is because hardware buffers generally may not be written to and read from at the same time.

A check at diamond 32 determines whether this is the last element in the data stream. If so, the flow ends; otherwise, the flow cycles back to block 24. In the case where the accessed element is the element to be stripped, as determined in diamond 26, the previously written element is read as indicated in block 34 in one embodiment. In other words, the previously written element may be read but the accessed element is not written into a buffer. Therefore, the element that is desired to be stripped is effectively discarded.

Alternatively, the element to be stripped can be written to a buffer. Then in the next write cycle it may be overwritten. As another alternative, an element may be written but never read. In general, any of a variety of techniques may be used to prevent the stripped data from ultimately being read out to form part of the output stream 19.

In the example provided in FIG. 1, the byte 5 may be written to the buffer 1, the byte 4 is not written, the byte 3 is written to buffer 2, the byte 2 is written to buffer 3 and the byte 1 is written to buffer 4. Each buffer 16 may be read out by the multiplexer 18 in the sequence: byte 5, byte 3, byte 2, byte 1, so that the data stream 19 is contiguous and uninterrupted.

More particularly, in the illustrated example, in the first cycle, the byte 5 may be written into the buffer 1 and the previously written element, if any, may be read out. In the next cycle, the byte 3 is written into the buffer 2 while the byte 5 is being read from a buffer 16 by the multiplexer 18. Similarly, the byte 2 is written into the buffer 3 while byte 3 is read from the buffer 2.

The number of buffers may be reduced to create a more efficient design. In general, with a firmware approach, the number of buffers that may be used equal the data clock size divided by the data size times the quantity one plus the number of data elements to be removed. In the case of a hardware implementation, wherein simultaneously reading and writing data from the same buffer is not permitted, the number of buffers may equal the data clock size divided by the data size times the quantity two plus the number of elements to be removed. The data clock size is the size of the data that is transferred in each clock cycle. The data size is the size of the data to be removed. The number of elements to be removed is how much data of the data size is to be removed.

Thus, in the example given in connection with FIG. 1, which involves a firmware embodiment, the data clock size and the data size are the same so the number of buffers may equal one plus the number of elements to be removed or two buffers. In such case, the buffers 16 labeled buffer 1 and buffer 2 may be the only buffers that are used in one embodiment. In such an embodiment, byte 5 may be written to buffer 1, byte 4 is not written, byte 3 is written to buffer 2, byte 2 may then be written back to buffer 1 (after byte 5 has already been read out), and byte 1 may be written to buffer 2 (after byte 3 has already been read out). Thus, by using a wraparound technique, a smaller number of buffers may be utilized.

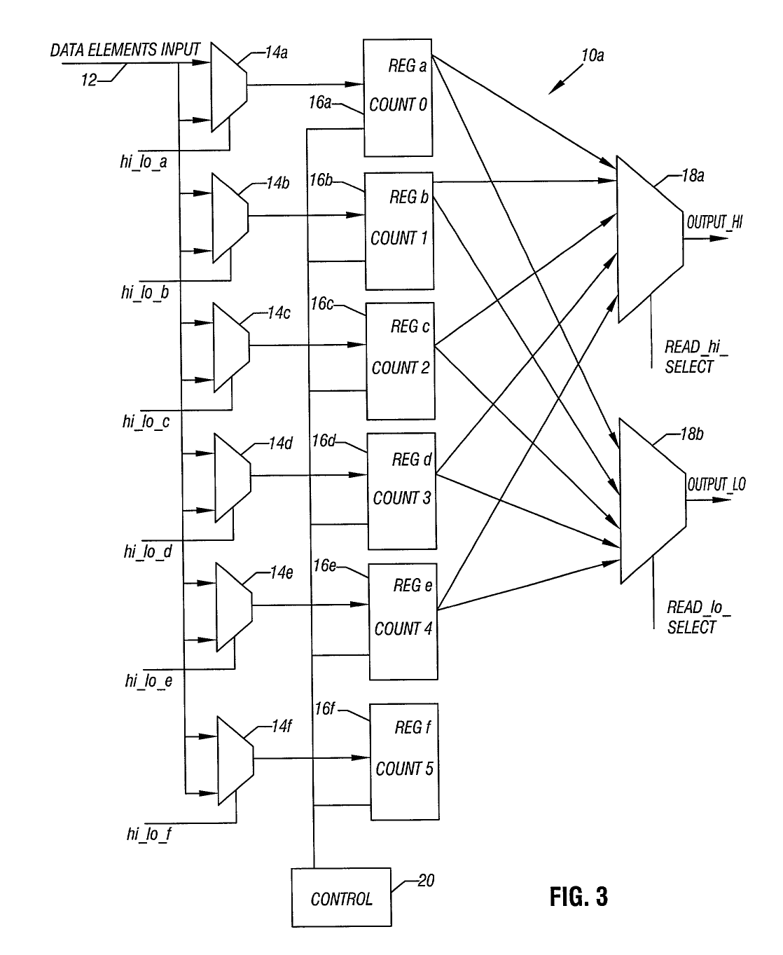

Referring to FIG. 3, a hardware device 10a, that may be part of an Ethernet adapter for example, strips VLAN tags on receipt, in accordance with one embodiment of the present invention. Of course, the stripping may also be done using software or firmware approaches. The data element stream 12 may be a ten gigabit per second Ethernet data stream in one example. The data arrives at 12, eight bytes at a time in such an example. The first eight bytes have no VLAN tags and the second eight bytes include four bytes of VLAN tags. Those four bytes are the last four bytes of the second eight bytes. Thus, the thirteenth through the sixteenth bytes in the data stream are known to be VLAN tags in a ten gigabit per second Ethernet example.

While an example is provided for stripping VLAN tags from a ten gigabit per second data stream, embodiments of the present invention can be used in a variety of data stripping applications.

In this example, since the size of the VLAN tag is four bytes, and the VLAN tag is what is desired to be stripped, the data elements are four bytes and the buffers or registers 16a-f, each have a capacity of four bytes. When the data elements 12 arrive, the first four bytes are passed by the first multiplexer 14a, under control of the control 20, to the register 16a. The next four bytes may be passed through the multiplexer 14b to the register 16b. The next four bytes may be passed by the multiplexer 14c to the register 16c. In one embodiment, the next four bytes, which correspond to the VLAN tag, may be passed to the register 16d.

The next four byte element is written to the register 16d through the multiplexer 14e so as to overwrite the VLAN tag previously stored in the register 16d. This may be done under the control of the control 20, that knows where in the data stream, the data to be removed (i.e., the VLAN tag) resides. Thereafter, the successive elements are written into each register such as the registers 16e and 16f. Reading from registers 16 may occur after writing to the registers 16a through 16d and writing over the contents of the register 16d to overwrite the VLAN tag data originally written into the register 16d.

Thus, when the register 16d is finally read, it has already been overwritten with a non-VLAN tag data element. Each of the registers 16 is then read out through a multiplexer 18a or 18b. The registers 16 pass the data to either a high output register 18a or a low multiplexer 18b in one embodiment. High data is directed to the multiplexer 18a. Conversely if the register 16 has low data, that data is output through the multiplexer 18b. High data constitutes the first four bytes of an eight byte portion of data and low data is the corresponding second four bytes of the eight bit portion of data, in one embodiment.

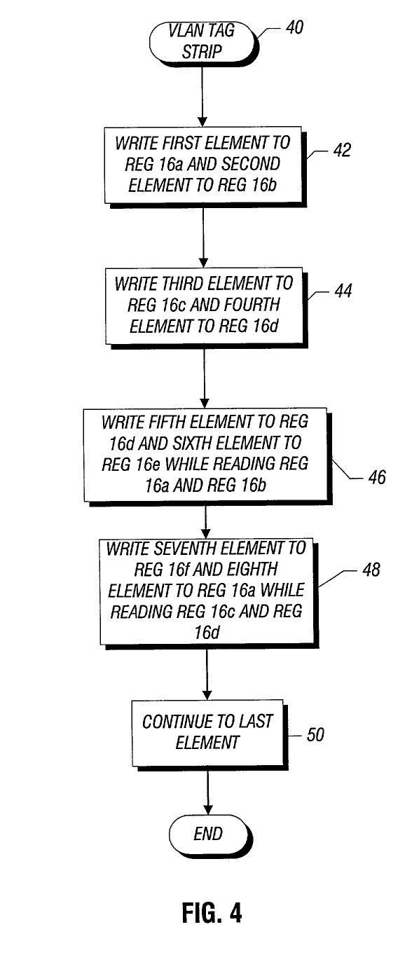

Thus, referring to FIG. 4, in one embodiment of the present invention, the software operative in the control 20 for stripping the VLAN tags in a ten gigabit per second example proceeds by writing a first four byte element to the register 16a and a second four byte element to the register 16b, as indicated in block 42. The third element is written to the register 16c and a fourth element, that includes a VLAN tag, is written to the register 16d, as indicated in block 44.

Thereafter, the fifth element is also written to the register 16d, overwriting the VLAN tag information previously written into the register 16d. The sixth element is written to the register 16e. At the same time, the registers 16a and 16b are read, all as indicated in block 46. More particularly, the register 16a passes the high data of the first eight bytes to the multiplexer 18a and the register 16b passes the low data of the first eight bytes to the multiplexer 18b.

Then, as indicated in block 48, the seventh element is written to the register 16f and the eighth element is written to the register 16a, while reading the elements from the registers 16c and 16d out through the multiplexers 18a and 18b. The registers 16 and multiplexers 18 are controlled to output the high elements through multiplexer 18a and the low elements through the multiplexer 18b. Again, this may be done under the control of the control 20, which provides the read_hi_select signals to the multiplexer 18a and the read_lo_select signals to the multiplexer 18b in one embodiment. In this way, by the time the register 16d, which would normally include the VLAN tag data, is read, the register 16d has already been written with the ensuing data that does not include the VLAN tag.

Since FIG. 3 is a hardware embodiment, the number of buffers equals six. This is derived by dividing the data clock size, which is eight bytes, by the data size, which is four bytes, and multiplying that number times two plus the number of elements to be removed, which is one, in this case (2×(2+1)). Thus, six buffers are utilized in the embodiment shown in FIG. 3. Of course, with a firmware embodiment, only four buffers are needed because firmware may allow simultaneously writing and reading from the same buffer.

As a result, in some embodiments, data may be contiguously output in uninterrupted fashion, substantially in real time, without substantially decreasing the speed of processing the data. The amount of hardware that is needed is relatively small, in some embodiments. For example, in the Ethernet VLAN stripping example shown in FIG. 3, only six half buffers are used, using three clocks. The arrangement shown in FIG. 3, for example, provides easy timing and a relatively high speed design. At the same time, an extra buffer, in one embodiment, guarantees that a buffer is used between the read and write multiplexing.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying a first data element to be removed from a data stream including other data elements;
writing the other elements into buffers and reading those elements from the buffers; and
preventing the first data element from being read from any of said buffers.

2. The method of claim 1 wherein identifying a first data element to be removed includes identifying the location of virtual local area network tags within the data stream.

3. The method of claim 1 wherein preventing the first data element from being read from any of said buffers includes preventing said first data element from being written to any of said buffers.

4. The method of claim 1 wherein preventing the first data element from being read from any of said buffers includes writing the first data element into a buffer and then overwriting said first data element in said buffer with one of said other data elements.

5. The method of claim 1 wherein writing the other elements into buffers includes writing the other elements into buffers having a size comparable to the size of said first data element.

6. The method of claim 1 including producing a contiguous uninterrupted output data stream with said first data element removed.

7. The method of claim 1 including receiving a data stream including said first data element and other data elements and distributing said other data elements to a plurality of buffers.

8. The method of claim 7 including reading said data elements out of said buffers through a multiplexer to generate a contiguous data stream.

9. The method of claim 1 including receiving a data unit that includes two data elements, storing one of said two data elements in a first buffer and the other of said two data elements in a second buffer.

10. The method of claim 9 including outputting one of said two data elements through a first multiplexer and outputting the other of said data elements through a second multiplexer.

11. An article comprising a medium storing instructions that enable a processor-based system to:
identify a first data element to be removed from a data stream to include other data elements;
write the other elements into buffers and read those elements from the buffers; and
prevent the first data element from being read from any of said buffers.

12. The article claim 11 further comprising a medium storing instructions that enable a processor-based system to identify the location of virtual local area network tags within the data stream.

13. The article of claim 11 further comprising a medium storing instructions that enable a processor-based system to prevent said first data element from being written to any of said buffers.

14. The article of claim 11 further comprising a medium storing instructions that enable a processor-based system to write the first data element into a buffer and then overwrite said first data element in said buffer with one of said other data elements.

15. The article of claim 11 further comprising a medium storing instructions that enable a processor-based system to write the other elements into buffers having a size comparable to the size of said first data element.

16. The article of claim 11 further comprising a medium storing instructions that enable a processor-based system to produce a contiguous uninterrupted output data stream with said first data element removed.

17. The article of claim 11 further comprising a medium storing instructions that enable a processor-based system to receive a data stream to include said first data element and other data elements and distribute said other data elements to a plurality of buffers.

18. The article of claim 17 further comprising a medium storing instructions that enable a processor-based system to read said data elements out of said buffers through a multiplexer to generate a contiguous data stream.

19. The article of claim 11 further comprising a medium storing instructions that enable a processor-based system to receive a data unit that includes two data elements, store one of said two data elements in a first buffer and the other of said two data elements in a second buffer.

20. The article of claim 19 further comprising a medium storing instructions that enable a processor-based system to output one of said two data elements through a first multiplexer and output the other of said data elements through a second multiplexer.

21. A system comprising:
a device to receive a plurality of data elements;
a plurality of buffers coupled to said device; and
a control to identify a first data element to be removed from a data stream to include other data elements, to write the other data elements into the buffers and read those elements from the buffers, and to prevent the first data element from being read from any of said buffers.

22. The system of claim 21 wherein said system is an Ethernet adapter.

23. The system of claim 21 wherein said system strips virtual local area network tags from said data stream.

24. The system of claim 21 wherein said control prevents the first data element from being read from any of said buffers.

25. The system of claim 21 wherein said control writes the first data element into a first buffer of said buffers and then overwrites the first data element in said first buffer with one of said other data elements.

26. The system of claim 21 wherein said buffers have a size comparable to the size of said first data element.

27. The system of claim 21 wherein said system produces a contiguous uninterrupted output data stream with said first data element removed.

28. The system of claim 21 including at least one multiplexer coupled to said buffers to store said other data elements.

29. The system of claim 28 including an output multiplexer coupled to said buffers to generate a contiguous data stream.

30. The system of claim 29 including a pair of output multiplexers, data units received by said device being separated into a least two separated data units, said separated data units being output from different ones of said output multiplexers.

31. The system of claim 21 wherein the number of buffers equals the data clock size divided by the data size times the quantity of one plus the number of data elements to be removed.

32. The system of claim 21 wherein the number of buffers equals the data clock size divided by the data size times the quantity of two plus the number of data elements to be removed.
